(19) United States
(12) Patent Application Publication
(10) Pub. No.: US 2013/0231180 A1
(43) Pub. Date: Sep. 5, 2013

(54) NETWORKED GAMING SYSTEM INCLUDING ANONYMOUS PLAYER BIOMETRIC IDENTIFICATION AND TRACKING

(71) Applicant: BALLY GAMING, INC., Las Vegas, NV (US)

(72) Inventors: Bryan Kelly, Pleasanton, CA (US); Bruce Rowe, Las Vegas, NV (US); JP Cody, Austin, TX (US)

(73) Assignee: BALLY GAMING, INC., Las Vegas, NV (US)

(21) Appl. No.: 13/786,238

(22) Filed: Mar. 5, 2013

Related U.S. Application Data
(63) Continuation of application No. 12/269,712, filed on Nov. 12, 2008, now abandoned.
Application No. 12/269,712 is a continuation-in-part of application No. 11/558,836, filed on Nov. 10, 2006.
Application No. 11/558,836 is a continuation-in-part of application No. 11/225,770, filed on Sep. 12, 2005, now abandoned.
(60) Provisional application No. 60/987,196, filed on Nov. 12, 2007.
(60) Provisional application No. 60/987,218, filed on Nov. 12, 2007.
(60) Provisional application No. 61/019,473, filed on Jan. 7, 2008.

(51) Int. Cl. G07F 17/32

(52) U.S. Cl. CPC G07F 17/3241
USPC 463/29

(57) ABSTRACT

A system and method are set forth which provides for biometric identification at a first server of an identified user and an established anonymous user and a device such as a gaming device and for using a second device such as a cellular telephone interfacing with the device to also access a second server which may also store biometric information as well as chargeable account information. If a user cannot be identified the first server establishes a new anonymous player account. Location determination may also be used where use of the device is subject to area use restrictions, such as remote gaming, to enable or disable the restricted use.

### CROSS REFERENCE TO RELATED APPLICATION

This application is a continuation application of application Ser. No. 12,269,712 filed Nov. 12, 2008 and titled “Networked Gaming System including Anonymous Player Biometric Identification” which in turn claims priority from U.S. provisional patent application 60/987,196 filed on Nov. 12, 2007, U.S. provisional patent application 60/987,218, U.S. provisional patent application 61/019,473 filed on Jan. 7, 2008, and is a continuation-in-part of application Ser. No. 11/558,836 filed Nov. 10, 2006 and titled “Affiliated Gaming System” which claims priority as a continuation-in-part of application Ser. No. 11/470,606 filed Sep. 6, 2006 which is a continuation-in-part of application Ser. No. 11/225,770 filed on Sep. 12, 2005 each of which are hereby incorporated by reference in their entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to networked gaming machines, systems, and methods, and more particularly to gaming machines, networked gaming systems, and methods with anonymous biometric identification of players.

2. Description of Related Art

Biometric devices and instruments have been previously disclosed for use with gaming devices. These devices and instruments have generally for use with identifying and verifying the identity of a player whose data is stored in a network-connected database.

However, there continues to be a need for improved biometric identification of players and patrons, particularly anonymous players and patrons, for various purposes, such as for providing player rewards or identifying and restricting players and patrons who have been identified as problem gamblers or those who may attempt illegal activities.

### SUMMARY

In accordance with one or more embodiments, networked gaming systems and methods with integrated biometric recognition for identifying a player at a gaming device with or without an identified player card. Other aspects of the inventions may include providing player rewards or services, restricting the activities of identified problem gamblers or banned players, and/or restricting illegal activities, such as money laundering and counterfeiting.

Further aspects, features and advantages of various embodiments of the disclosed embodiments may be apparent from the following detailed disclosure, taken in conjunction with the accompanying sheets of drawings.

### BRIEF DESCRIPTION OF THE DRAWINGS

FIG. 1 illustrates a system component panel on a gaming device that includes a proximity detection system in accordance with one or more aspects of the invention.

FIGS. 2A and B illustrate example components of an electronic gaming machine in accordance with one or more aspects of the invention.

FIGS. 3A and B illustrate an example enterprise gaming system that may extend over multiple locations in accordance with one or more aspects of the invention.

FIG. 4 illustrates an example gaming machine that has been disabled for play in accordance with one or more aspects of the invention.

FIG. 5 illustrates an example anonymous player centric reconfiguration/re-skin/download of a gaming device or server based gaming system based upon past game play wager/win/loss history, session history, game ID information in accordance with one or more aspects of the invention.

FIG. 6 illustrates an example process for anonymous player self exclusion responsible gaming in accordance with one or more aspects of the invention.

### DETAILED DESCRIPTION OF THE PREFERRED EMBODIMENTS

Various embodiments described herein are directed to an improved biometric recognition system for identifying a player at a gaming device with or without an identified player card, integrated with a networked gaming system. The embodiments as illustrated and described herein, are discussed by way of example only and not by way of limitation.

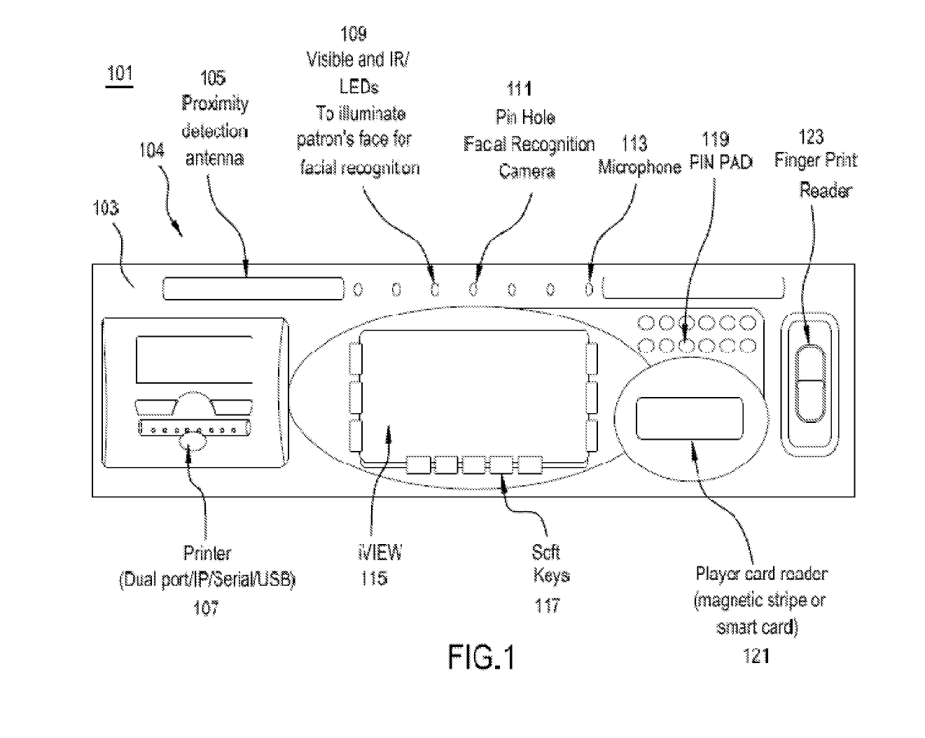

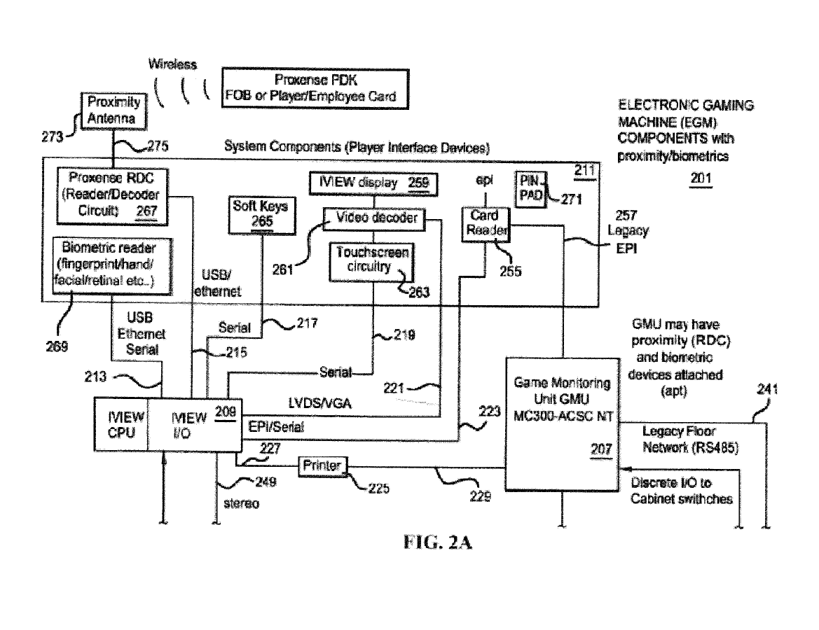

With reference to FIGS. 1-6, there are shown illustrative examples of proximity detection systems integrated with gaming machines, a gaming network, processes, and various related GUI displays all of which may be connected to a user control station, such as a Bally Control Panel connecting to a Bally SDS or ACSC Casino Management System (CMS) and/or Slot Management System (SMS), to facilitate the development and delivery of player services, such as player rewards or restricting play activity of identified problem gamblers or banned players, or preventing illegal activities, such as money laundering or counterfeiting, in accordance with various aspects of the invention.

Referring to FIG. 1, is a player interface unit 101, such as may be modified from a Bally iView player interface unit and installed on a gaming device with a conventional cavity area sized and proportioned for a Bally iView. Player interface unit 101 may be conventionally mounted on a metal bracket within a conventional gaming machine. Commonly, a player interface unit is mounted in a space above the primary display and below a secondary display; however, the player interface unit may be located in a space below the primary display or any other location about a given gaming device where there is easy access for a patron.

Player interface unit 101 includes front panel 103 connecting to a controller board with a processor and memory accessible by the processor. The memory may include random access memory, ROM, PROM, EEPROM storage media and store a player interface main program and various subroutines and functions including device drivers executable on the processor. Also, the memory may include network communication and game programming to enable one or more games to be played by player interface unit 101 and/or communicate with a server to send and receive various game and/or player-related information. The processor may be a conventional microprocessor or controller. The controller board may connect directly to a server network through a conventional network port or may connect to another device, such as a Bally Game Management Unit (GMU), which in turn connects to the server network. Integrated with front panel 103, external portions of various player-related components 104 may include: proximity detection antenna 105, printer 107, visible and infrared LEDs 109 may be arranged to illuminate patrons face for facial recognition, pinhole camera 111 for facial recognition and image capture purposes, a microphone 113 for communication by the player to the casino help desk, video display 115 with interactive soft keys 117, pin pad 119 for entering data such a personal identification number or password, player card reader 121, and fingerprint reader 123.

Player-related components 104 are commercially available. Player-related components 104 connect to the processor and may be operable together with the processor through respective device drivers, circuitry and programming. Proximity detection antenna 105 may be part of a proximity detection apparatus. For example, proximity detection antenna may be connected to a transducer which may emit and receive sonic signals. The player interface processor may cause the transducer to continuously transmit a periodic signal through the antenna. Sonic signals or other signals that may reflect back to the antenna may be utilized by the player interface processor to determine whether a patron has moved within a pre-determined perimeter of the front of a respective gaming device. Additionally, pressure sensitive sensors or light emitter/detectors may be placed under or over a carpet to detect the presence of a patron within a pre-selected perimeter, such that when a patron is standing on one or more of the sensors and/or emitter/detectors, a signal may be generated and transmitted to the gaming machine which may respond according to its programming.

In one or more embodiments, light wave signals, such as low power lasers, may be used for distance measuring and proximity detection, or may be used for perimeter breach. For example, a laser emitter may emit a steady state light stream across a walkway and a reflector may be placed on a gaming machine on the other side of the walkway; when the light beam ceases to reflect then a patron has broken the perimeter. Laser emitter/reflector/receivers may be placed on each side of a gaming machine, so that when one light beam is broken, the gaming machine may receive a signal that a patron is within the perimeter and when the other light beam is broken the gaming machine may receive a second signal indicating that the patron has departed the perimeter. In other embodiments, reflectors may be embedded on the floor about the gaming machine such as in a semi-circle (or part of a semi-circle to accommodate a chair) about the front of the gaming machine. Similarly, reflectors may be embedded as part of a chair. In each case, the approach of a patron may be detected and the gaming machine may respond accordingly. The reflection of light versus sound or radio waves may be much faster due to the difference in the speeds that light versus sound travels. Radio wave signals may also be utilized as discussed herein and also described in U.S. Pat. No. 7,305,560 which is hereby incorporated by reference. Ultra-sonic or thermal presence (heat) and/or motion sensors may also be utilized together with imaging technology, such as night-vision technology. Also, some sensors may be sufficiently sensitive to receive reflections of waves including light waves and therefore extrinsic reflectors, such as those that may be used in security alarm systems, may be eliminated.

Upon a determination that a patron has moved within the perimeter, the processor may generate a camera activation signal causing the LEDs 109 to illuminate the patron's face and for camera 111 to capture an image and transmit the image to the control board for either further processing or for transmission to an external receiver. Such that the facial image may be compared against a database of stored facial images to identify a known or returning anonymous patron using detection and/or matching filter circuitry and/or programming. In the case that no match is determined, then the patron may be identified as anonymous and the detection system may be programmed in such a case to associate a new anonymous account with the facial image.

In one or more embodiments, the facial recognition software may be response to a presence detection signal transmitted by an associated sensor. For example, the camera or imaging equipment may continuously capture images at a slow rate until a change in the captured image is detected, such as an image being detected that has a size corresponding to the size of a facial image; thereupon, the image capture rate may be accelerated as the image software seeks a sufficiently good image based upon imaging software, such as with iterative image enhancement filter algorithms. Upon a determination by the software that a sufficiently good image has been captured, then the scan or estimated image may be transmitted and/or utilized for biometric comparison.

Microphone 113 may be operably connected to the player interface board. The processor or other circuitry may be used to digitize and amplify the audio signal received from the microphone. The amplified signal may be transmitted to an external receiver to communicate with an attendant or may be utilized by detection and/or matching filter circuitry to analyze the voice pattern against other patterns to determine identity by comparison with other stored voice patterns. The voice pattern may also be used as an age screen, such as to prevent underage gaming, whereby pre-identified audio patterns may be associated with selected age groups. Stored audio patterns may be stored on a memory directly associated with a player interface unit or may be remotely stored, such as on a server or server-connected database, and remotely analyzed through a processor, such as a network-connected server processor. In the case of using the microphone as a communication interface, a speaker (not shown) may be connected to the player interface board and the player interface board may receive external communications, such as from an attendant, transform and amplify the attendant's audio signal as with a digital-to-analog (D/A) circuit and amplifier circuitry and output the amplified analog audio signal through the speaker so that the patron may hear the message, instruction, or inquiry from a remote attendant.

In one or more embodiments, the facial scan may be used to authorized access by casino employees to gaming machines, service menus on gaming machines, and/or close transactions that have occurred on the gaming machine, such as hand pays. Facial scans may also be used to provide tiered levels of access to casino employees of differing access authorizations.

Pin pad 119 may be used together with display 115 and softkeys 117 for use in identifying a patron, such as through the use of a personal identification number. Player card reader 121 may also be used as part of the identification process by receiving a player card. Upon detection of a player card, the processor may transmit a message or instruction that may be displayed on display 115. For example, the card may have sufficient identifying information to identify the name and account of a patron. (This is an example of a known patron and the identification process may be programmed for the purposes of correctly identifying a patron and providing the patron access to player account privileges and awards associated with the player's account.)

Independently, or in conjunction with any of the other player interface devices, fingerprint reader 123 may be used to read a fingerprint image and transmit the image data to the player interface board for further processing or transmission to a remote receiver, such that the fingerprint may be compared against a database and associated with a patron. Any combination of the foregoing devices and programming may be utilized to either identify a known or returning anonymous patron or may be associated with a new anonymous account in the case of a first-time patron being determined.

In one or more embodiments, upon identification of a patron, either known or anonymously, a stored fingerprint and/or facial image may be compared with the current image. The gaming machine wagering operation may be tied to the image verification process, such that the gaming machine may be disabled unless a verified fingerprint or facial image is detected at or immediately prior to initiation of a wager. Such a mechanism may be utilized either on the gaming floor or in remote locations to verify the identity of the individual initiating a wager. Also, location identification, such as by GPS, may be utilized together with the biometric identification in order to limit wagering to a specific area, such as licensed premises. In one or more embodiments, both an optical and heat image may be utilized; such as to require that a thumbprint be verified and the thumb be touching or in adjacent proximity to the fingerprint sensor and/or imager at the time a wager is initiated. Heat signatures of a thumb or other digit or palm may be utilized as part of this verification process. Heat signatures may be obtained from conventional thermal, infrared, or other conventional sensors.

In one or more embodiments, near field communication (NFC) technology may be implemented with player interface unit 101, such as a Bally iView), and used in conjunction with biometric identification as discussed herein to enable initiation of wagering transactions. For example, a patron identified biometrically may carry a device, such as a cell phone or credit card, with a unique signature that may be identified and associated with an account by the gaming machine. The patron may initiate a wager. Thereupon or prior thereto, the gaming machine may verify the account and obtain an electronic authorization for a charge to the account by an external server carrying the account, such as Bell South Mobility (where the account is a cell phone account) or Bank of America (where the account is a credit or debit account maintained with the bank by the patron). The respective third party companies may also have biometric information that may be verified as part of the transaction by comparison with the biometric data obtained by the gaming machine. Apart from simple proximity of a cell phone or credit card with a unique electronic signal that may be received wirelessly, the gaming machine may have a receptacle for receiving the device, such as a card reader or serial connection hub for connecting a cell phone, personal data assistant, laptop computer, or other electronic device capable of transmitting chargeable account information, password, and/or biometric information to initiate a secure transaction with the gaming machine.

By example, Near Field Communication or NFC, is a short-range high frequency wireless communication technology which enables the exchange of data between devices over about a 10 centimeter (around 4 inch) distance. The technology may be a simple extension of the ISO 14443 proximity-card standard (contactless card, RFID) that combines the interface of a smartcard and a reader into a single device. An NFC device can communicate with both existing ISO 14443 smartcards and readers, as well as with other NFC devices, and is thereby compatible with existing contactless infrastructure already in use for public transportation and payment. NFC may be used with mobile phones or other mobile devices. NFC communicates via magnetic field induction, where two loop antennas are located within each other's near field, effectively forming an air-core transformer. It operates within the globally available and unlicensed radio frequency ISM band of 13.56 MHz, with a bandwidth of almost 2 MHz. Working distance with compact standard antennas: up to 20 cm. Supported data rates: 106, 212, or 424 kbit/s. There are two modes:

Passive Communication Mode: The Initiator device provides a carrier field and the target device answers by modulating existing field. In this mode, the Target device may draw its operating power from the Initiator-provided electromagnetic field, thus making the Target device a transponder.

Active Communication Mode: Both Initiator and Target device communicate by alternately generating their own field. A device deactivates its RF field while it is waiting for data. In this mode, both devices typically need to have a power supply.

In one or more embodiments, an anonymous or known patron locator-based system may be implemented, such as by utilizing a GPS-equipped locator server in conjunction with cellular phones including an A-GPS chip. In the simplest implementation, the exact location of each GPS-cell phone may be identified throughout a casino by programming the locator server to poll the GPS-cell phone signals on a periodic basis. GSM location is another option for locating cell phone or GSM-portable device carrying patrons and employees. Finding the location of a mobile device in relation to its cell site is another way to find out the location of an object or a person. It relies on various means of multilateration of the signal from cell sites serving a mobile phone. The geographical position of the device is found out through various techniques like time difference of arrival (TDOA) or Enhanced Observed Time Difference (E-OTD). Alternatively, triangulation may be used similar to GPS systems where various device emitters located throughout a floor or section may transmit a signal and have a location that is known to the locator server. The transmitted signals may be received by the respective GPS-cell phones and the information about the received signal including the time between pulses received may in turn be transmitted to the locator server which may use the data of several device emitters received by a given GPS-cell phone to triangulate the location of the respective GPS-cell phone. Similarly, a GSM-device may be located using associated GSM emitters or transceivers.

Another example is Near LBS (NLBS), in which local-range technologies such as Bluetooth, WLAN, infrared and/or RFID technologies are used to match devices to nearby services. This application allows a person to access information based on their surroundings; especially suitable for using inside closed premises, restricted/regional areas.

Another alternative is an operator- and GPS-independent location service based on access into the deep level telecoms network (SS7). This solution enables accurate and quick determination of geographical coordinates of mobile phone numbers by providing operator-independent location data and works also for handsets that are not GPS-enabled.

A user interface control station, such as a Bally Control Panel station, may be implemented to connect to the locator server and display the location of both patrons and employees carrying GPS-cell phones. Thereby, an operator may obtain a display of a floor plan or section wherein various gaming machines and service stations may be identified together with the locations of the GPS identified patrons and employees. Additionally, a dispatch server may be connected to the control station and/or locator server to direct employees to assist patrons. Locator and dispatch server may replace RTCEM server 337 and utilize locator technology as described herein which is contemplated as an alternative to the Proxense-type personal digital key RF transceivers as described in U.S. provisional patent application 60/987,218. Similarly, patron beverage and other requests may be routed through the locater and/or dispatch server from a user interface device, such as an iView, and, an authorized employee identified in the vicinity of the patron may be signaled by conventional communication technology connected with the dispatch server of the need for service to an identified patron.

The control station may be utilized as a passive monitoring device for an operator to record and view gaming and/or service activity of selected patrons and/or employees, such that an operator may initiate changes to employee locations or staffing to meet service needs for patrons and the casino operator at selected times. The control station may also be used as an active device, so that an operator may receive patron requests, such as drink or food requests, or, initiate employee engagement with selected patrons for various purposes, such as signing up for a player card or requesting identification for age verification.

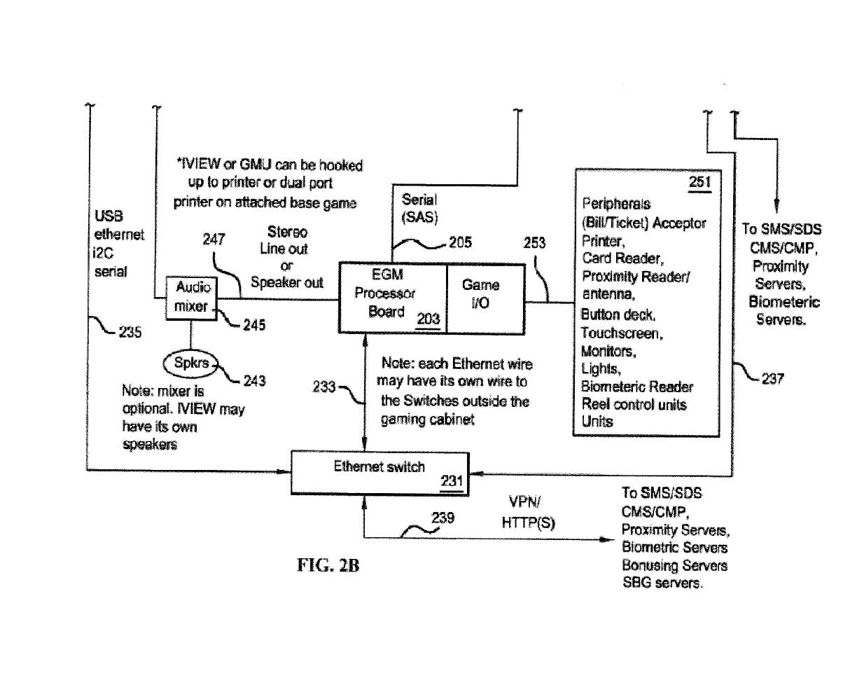

Referring to FIGS. 2A and B, electronic gaming machine 201 is shown including proximity detector and biometric device components in accordance with one or more embodiments. Electronic gaming machine 201 includes base game integrated circuit board 203 (EGM Processor Board) connected through serial bus line 205 to game monitoring unit (GMU) 207 (such as Bally MC300-ACSC NT), and player interface integrated circuit board (PIB) 209 connected to player interface devices 211 over bus lines 213, 215, 217, 219, 221, 223. Printer 225 is connected to PIB 209 and GMU 207 over bus lines 227, 229. EGM Processor Board 203, PIB 209, and GMU 207 connect to Ethernet switch 231 over bus lines 233, 235, 237. Ethernet switch 231 connects to a slot management system (SMS) and a casino management system (CMS) network over bus line 239. GMU 207 also may connect to the SMS and CMS network over bus line 241. Speakers 243 connect through audio mixer 245 and bus lines 247, 249 to EGM Processor Board 203 and PIB 209. Peripherals 251 connect through bus 253 to EGM Processor Board 203. The various components and included devices may be installed with conventionally and/or commercially available components, devices, and circuitry into a conventional and/or commercially available gaming machine cabinet. The proximity and biometric devices and circuitry may be installed by upgrading a commercially available PIB 209, such as a Bally iView unit. Coding executed on EGM Processor Board 203, PID 209, and/or GMU 207 may be upgraded to integrate the proximity and biometric devices and utilize the information as is more fully described herein.

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

EGM Processor Board 203 includes a game microprocessor, such as an Intel Pentium, and memory which may both be onboard memory, such as cache, ROM, EEPROM, and, offboard memory, such as flash or hard drive memory. Gaming operating system and game software are stored in the memory and executable by the game microprocessor for executing gaming operations on gaming machine 201 including providing one or more wagering games for a patron.

Example pseudo-code executed by the game microprocessor may include:

| | |
|---|---|
| Start | |
| if game activated, | |
| call game sequence | % causing random number generator to |
| | % determine a game outcome, presenting a game |
| | % display such as mechanically or video spinning |
| | % reels for a predetermined period, stopping the |
| | % reels to show the determined game outcome, |
| | % paying any awards by increasing the credit |
| | % meter, advancing any other game state meters, |
| | % and transmitting selected game play |
| | % information including player information |
| | % through the Ethernet switch to the SMS/CMS |
| | % network. Depending upon programming, said |
| | % information may be transmitted directly by |
| | % EGM Processor Board 203 to the SMS/CMS |
| | % network; alternatively, EGM Processor Board |
| | % 203 may enable the information to be |
| | % provided to PID 209 and/or GMU 207 for |
| | % transmission to the SMS/CMS). |
| else | |
| call attract mode | % causing a sample display of a game sequence |
| | % or presenting a display of a set of options for a |
| | % player to initiate a game sequence such as |
| | % minimum wager ($0.25, $1, $5) selection |
| | % buttons in the case of a touch panel display. |
| Go to Start | % Upon one or more activating signals, ending |
| | % attract mode and returning to Start |
| end | |

Additional subroutine and/or function sequences may be initiated on EGM Processor Board 203 prior to game activation through the use of signals generated by proximity or biometric sensors whereby the presence of a patron may be detected prior to the patron initiating any physical contact with gaming machine 201. One or more of the signals may be received by EGM Processor Board 203 from PID 209 as through Ethernet switch 231 or through some additional path (not shown) such as directly connecting PID 209 and EGM Processor Board 203, connecting PID 209 through GMU 207 to EGM Processor Board 203, connecting GMU 207 to EGM Processor Board 203 in the case where GMU 207 may directly receive signals from proximity and/or biometric sensors, or connecting EGM Processor Board 203 to directly receive signals from proximity and/or biometric sensors.

For example, an additional subroutine may include pseudo-code:

If proximity stimuli signal received

| | |
|---|---|
| call welcome sequence | % An audio visual welcome sequence may |
| | % be initiated to encourage the patron to |
| | % initiate play, such as a video image of a |
| | % person coupled with an audio sequence |
| | % ‘Welcome, Pardner. Why don't you sit |
| | % down and rest your heals for a little |
| | % while. We've got a wham-bang game |
| | % here, all you need to do is to slip a bill |
| | % into the bill receiver, select your wager, |
| | % and press the ‘go’ button.’ |

GMU 207 includes an integrated circuit board and GMU processor and memory including coding for network communications, such as the SAS protocol used for system communications over the network. As shown, GMU 207 may connect to card reader 255 through bus 257 and may thereby obtain player card information and transmit the information over the network through bus 241. Gaming activity information may be transferred by the EGM Processor Board 203 to GMU 207 where the information may be translated into a network protocol, such as SAS, for transmission to a server, such as a player tracking server, where information about a patron's playing activity may be stored in a designated server database.

PID 209 includes an integrated circuit board, PID processor, and memory which includes an operating system, such as Windows CE, a player interface program which may be executable by the PID processor together with various input/output (I/O) drivers for respective devices which connect to PID 209, such as player interface devices 211, and which may further include various games or game components playable on PID 209 or playable on a connected network server and PID 209 is operable as the player interface. PID 209 connects to card reader 255 through bus 223, display 259 through video decoder 261 and bus 221, such as an LVDS or VGA bus, proximity detector 267 through bus 215, and biometric imager/s 269 through bus 213.

As part of its programming, the PID processor executes coding to drive display 259 and provide messages and information to a patron. Touch screen circuitry interactively connects display 259 and video decoder 261 to PID 209, such that a patron may input information and cause the information to be transmitted to PID 209 either on the patron's initiative or responsive to a query by PID 209. Additionally soft keys 265 connect through bus 217 to PID 209 and operate together with display 259 to provide information or queries to a patron and receive responses or queries from the patron. PID 209, in turn, communicates over the CMS/SMS network through Ethernet switch 231 and busses 235, 239 and with respective servers, such as a player tracking server.

For example, PID 209 may have coding which is stored in local memory and executable by PID processor upon insertion of a player card into card reader 255 and follows a sequence such as:

| | |
|---|---|
| Card detected | % A signal from card reader transmits to |
| | % PID 209 upon insertion |
| Read patron card | % A player card has identifying information |
| information | % which may be used to identify a |
| | % corresponding record in a player |
| | % database where player tracking |
| | % information is maintained, such as a PIN |
| | % number for verifying a patron and the |
| | % inserted card. |
| Access player account | % A msg may be transmitted to a player |
| | % tracking server where a player account |
| | % database may be maintained and |
| | % accessed; the record may be located |
| | % using the information from the player |
| | % card. |

Display patron welcome msg with patron's name
If patron's account has any information to be displayed,

| | |
|---|---|
| Display additional | % For example, if patron has accumulated |
| information | % bonus points or has any bonus or promo |
| | % awards, then the display may present |
| | % that information |

If player requests access to player's account,
Display query requesting input of PIN number

| | |
|---|---|
| | % A virtual key pad may be displayed |
| | % upon which the patron may press the |
| | % correct sequence of keys or a separate |
| | % PIN pad may be used, such as PIN pad |
| | % 271. Upon receipt, the input PIN may be |
| | % compared with a stored PIN associated |
| | % with the patron account. If the input PIN |
| | % corresponds then the patron is given |
| | % access to the account. |
| If PIN confirmed, | |
| Display available | % For example, associated with respective |
| options | % soft keys 265, display bonus awards or |
| | % promo credits available and enable |
| | % activation of bonus awards or download |
| | % of promo credits. |

Send transaction msg to EGM Processor Board effecting any authorized
credit transaction

% EGM Processor Board 203 controls the
% credit meter displayed to patron and
% controls release of credits to patron as
% through bus 253 connecting to
% peripherals 251. Pursuant to the
% transaction signal from PID 209, EGM
% Processor Board 203 transmits signal to
% credit meter and increases the number
% of credits by the authorized amount.

Proximity detector 267 includes proximity antenna 273 connected through bus 275 and emitter/receiver circuitry. Proximity detector 267 may utilize emitter/receiver technology, such as sonar, radar, radio frequency, whereby a signal may be emitted and a corresponding signal received. By example, sonar signals may be used to transmit a directed wave emanating from the gaming machine and having a 90 degree spread about the perpendicular access. If no one is in the area, then the sonar signal may bounce off the nearest gaming machine and the bounced signal may be received by proximity detector 267. The time elapsed in seconds from transmission to return may be calculated by reference to an onboard clock, a clock maintained by PID 209, GMU 207, or EGM Processor Board 203, or, a counter may be used. In the event of a sonic signal, the speed of sound is roughly 1100 ft/sec. If proximity detector 267 has a controller capable of making the calculation, coding may be implemented to process the distance of the nearest object such as through an algorithm:

distance_of_nearest_object=(time_elapsed/2)*1100 (ft)

The information may then be transmitted over bus 215 to PID 209. Alternatively, the PID processor may perform the calculation. Coding may be further implemented based on the distance of the nearest object. For example, an operator may simply want the gaming machine to identify patrons or employees within a selected distance of the gaming machine, or there may be different procedures that are executed depending upon the distance of the nearest object. In one or more embodiments, more sophisticated proximity detector devices may have more than one emitter/detector enabling limited determination of speed and direction of travel of a patron in addition to distance. For example, one emitter/detector may be located at or near one side of player interface panel 101 and a second emitter/detector may be located at or near the other side of player interface panel 101. By continuously sending pulses from each emitter spaced a pre-determined period of time apart, the data from the returning signals may be used to triangulate a person's movement through a pre-determined perimeter in front of gaming machine 201. For example, at t1 both sensors may separately send a pulse with a unique signature and receive a corresponding return pulse; the separate distances of an identified person from each sensor may be determined; at t2, both sensors repeat the same process; the distances measured at t1 and t2 may be used to obtain an approximate measure of speed and direction which may include applying assumptions based on the width of the aisle in front of the gaming machine. Also, the power of the emitters may be used to limit the distance prior to receiving a proximity signal or the circuitry or processor coding may limit analysis of signals within a predetermined distance perimeter of the gaming machine, such as three feet. If speed and direction is calculated, coding may be implemented on the PID processor triggered based on a patron slowing down within the proximity perimeter, based on a patron walking toward the gaming machine, or based on a patron stopping in front of the gaming machine but not close enough to be sitting down. In each case, a different audible greeting and video display may be generated on the gaming machine to capture a person's attention and encourage the person to sit and play a game on the gaming machine.

In one or more embodiments, radio frequency emitter/transmitters are utilized. In one or more of these embodiments, a resonator circuit may be embedded in player and/or employee cards or other electronic devices, such as a fob. The resonator circuit may emit a signal when it is within a perimeter of gaming machine 201 and that signal is received by proximity detector 267. In these embodiments, the radio emitter/s from gaming machine 201 may broadcast broadband and each patron and/or employee card may transmit a unique signal that may be used to identify the specific patron or employee by matching the signal signature with card signals stored in a patron and/or employee database/s and associated with either a player account or employee identification. Emitter power may be reduced to reduce the distance of acquisition of the patron and/or employee card signal signatures.

In one or more embodiments, both sonic or radar and radio frequency emitter/transmitters are utilized. In the case of sonic or radar detectors, all moving traffic is identified anonymously, enabling coding to be implemented in PID 209 to be responsive to anyone within a pre-determined distance, such that a general response may be provided to acknowledge, greet and/or encourage a prospective player. By also utilizing the radio detectors and cards or devices with resonator circuits, players and/or employees may be specifically identified and an acknowledgement or greeting may be personalized. Also, by being able to identify known patrons and/or employees, PID 209 may be able to determine that an anonymous patron is within its proximity perimeter and may respond with a generalized message for anonymous patrons, such as to encourage them to play and to obtain a player card. Utilizing proximity detector technology, an operator may also program selected gaming machines to transmit offers to selected subsets of patrons entering within a predetermined proximity of selected gaming machines 201. For example, upon detecting a platinum card patron within its perimeter, PID 209 may transmit an audio message through speakers 243 offering the patron a $20 promo credit for playing on selected gaming machine 201 at that time or during a predetermined space of time, such as during the next hour, two hours, four hours, or other predetermined space of time. Targeted offers may thus be made to patrons with different player ratings and also to anonymous players, such as to encourage them to sign up for a player card or simply just to encourage them to sit down and play.

Biometric devices 269, such as a finger print reader or a facial, retinal, or hand recognition camera, connect to PID 209 and may be utilized to identify both known and anonymous patrons and/or employees by comparison of imaging data from a patron and/or employee with an existing database which may be stored locally on gaming machine 201 or on a server database connected to the SMS/CMS network.

In one or more embodiments, more than one camera may be situated on the front panel and used to generate a three-dimensional image of patron biometric data, such as by placing a camera on each end of the front panel and using signal processing algorithms to merge the two dimensional images into a three dimensional image. The process and analysis as discussed herein may otherwise be followed.

An example coding sequence on PID 209 may include:

Receiving a proximity signal meeting a threshold distance from player

| | |
|---|---|
| interface panel 101 | % By example, a distance may be |
| | % preset at 2 ft. In the event that two |
| | % proximity detector sensors are |
| | % utilized, a determination can be |
| | % made whether a patron is sitting |
| | % in front of gaming machine 201. If |
| | % only one proximity sensor is used, |
| | % then a best guess will need to be |
| | % made or additional sensors may |
| | % be utilized, such as a weight |
| | % sensor which may be connected to |
| | % a seat in front of gaming machine |
| | % 201. For example, if a weight of |
| | % 90 lbs is determined to be placed |
| | % on the seat, then a patron may be |
| | % determined to be sitting in the |
| | % seat. Alternatively, once a patron |
| | % is within a predetermined |
| | % distance, then PID 209 may |
| | % assume that the patron is seated, |
| | % at which point a facial or retinal |
| | % image may be taken. |

Detect and capture image with camera
Determine whether captured image meets threshold

| | |
|---|---|
| | % Upon signaling the camera to |
| | % obtain an image and receipt of the |
| | % image, the PID processor may |
| | % compare the image with |
| | % predetermined threshold |
| | % requirements, such as distance |
| | % from ear to ear. In the event that |
| | % the threshold is not met, then |
| | % another image may be captured. |
| Compare image with database | % Once a threshold is met on a facial |
| | % or retinal scan, then the captured |
| | % information may be compared |
| | % with a stored known patron |
| | % and/or |
| | % employee image database using |
| | % detection and/or matching filter |
| | % algorithms. These algorithms may |
| | % also include predetermined |
| | % tolerances or thresholds to |
| | % determine a match. The |
| | % algorithms may be analog or |
| | % digital; however, in the case of |
| | % digital filter algorithms, the filters |
| | % may be implemented as adaptive |
| | % filters to provide more analytical |
| | % flexibility, alternatively the filter |
| | % algorithms may be classically- |
| | % based, such as Butterworth, K-L, |
| | % Chebyschev, and may be of a |
| | % predetermined filter-order for |
| | % acceptable confidence, such as a |
| | % 6^{th}, 8^{th}, 12^{th} order filter algorithm: |
| | % c = h * x => F{c} = F{h}F{x} |
| | % x = acquired image |
| | % h is a function of the stored |
| | % biometric data |
| | % C = HX |
| | % where the convolution algorithm |
| | % may be transformed using a |
| | % frequency transform, such as |
| | % Fourier, into a multiplicative |
| | % algorithm |
| | % For a detection algorithm, |
| | % H = 1 / E{S}² |
| | % where E{ } represents the |
| | % expectation value which will |
| | % correspond to the stored biometric |
| | % data. In the case of matching an |
| | % image, the algorithm may be a one |
| | % dimensional or two dimensional |
| | % algorithm. |

If no match, then compare image with anonymous patron database

% Anonymous patrons may be
% identified either through previous
% play where data is obtained and
% stored in a similar manner to a
% player with a card. An account is
% associated with an anonymous
% patron using biometric data
% during an anonymous patron's
% initial play at an operator's
% establishment. Thereafter, the
% anonymous patron may be
% identified using a biometric scan
% and matching the scan with a
% database maintained of
% anonymous patrons. In the case
% of known patrons, biometric
% imaging may be used in
% conjunction with a player card and
% eliminate a need for a PIN number
% entry for accessing a player
% account.
% Additionally,
% similar information may be
% obtained from various services
% concerning undesirables, such as
% persons with a history of illegal
% gaming activity.

If undesirable detected, then signal security or floor staff

%Once an
% undesirable is determined, a
% signal may be sent from PID or
% from a biometric analysis server to
% security or floor attendants
% depending on settings which may
% be implemented in coding and
% executed upon the determination.

If a known or anonymous patron is identified
Store account information
Monitor playing activity
Store playing activity information in association with the account

| | |
|---|---|
| | % Playing activity may be monitored |
| | % and transmitted periodically to |
| | % update player records, such as |
| | % accumulated bonus points |
| Periodically update player records | % Updates may be based on handle, |
| | % such as $1, $5, $10 of wagering |
| | % activity |

Periodically, capture and re-match player image

% It may be desirable to re-identify
% a patron for security, bonus
% awards, or other purposes during
% a gaming session.

If patron detected to have departed,
Close gaming session
Transmit final gaming information to player tracking database

% Patron departure may be
% determined by removal of player
% card, cashing out, determination
% that patron is no longer within a
% predetermined distance of player
% interface panel 101, or facial or
% retinal or other image is no longer
% within the thresholds for a viable
% determinable image. For example,
% it is not uncommon for fingerprint
% identification software to require
% four to six points to be identifiable
% as a threshold, prior to a
% fingerprint being viable for
% comparison and reliable matching
% with a fingerprint database.

In one or more embodiments, proximity detector 267 and proximity reader 269, camera, and/or fingerprint reader may connect directly to EGM Processor Board 203, GMU 207, or a special purpose IC processor Board for receiving proximity signals and/or performing proximity analysis through the respective processors as discussed herein with respect to the PID processor and player interface board 209. The database comparative analysis may be conducted onboard, if a biometric and player account database is maintained within the gaming machine or the player and biometric data may be transmitted externally over the network to a separate device, such as a biometric and/or player account server.

Player interface devices 211 are linked into the virtual private network of the system components in gaming machine 201. The system components include the iVIEW processing board and Game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using HTTPs over Ethernet. Through this connection, firmware, media, operating system software, gaming machine configurations can be downloaded to the system components from the servers. This data is authenticated prior to install on the system components.

The system components include the iVIEW processing board and Game monitoring unit (GMU) processing board. The GMU and iVIEW can combined into one like the commercially available Bally GTM iVIEW device. This device may have a video mixing technology to mix the EGM processor video signals with the iVIEW display onto the top box monitor or any monitor on the gaming device.

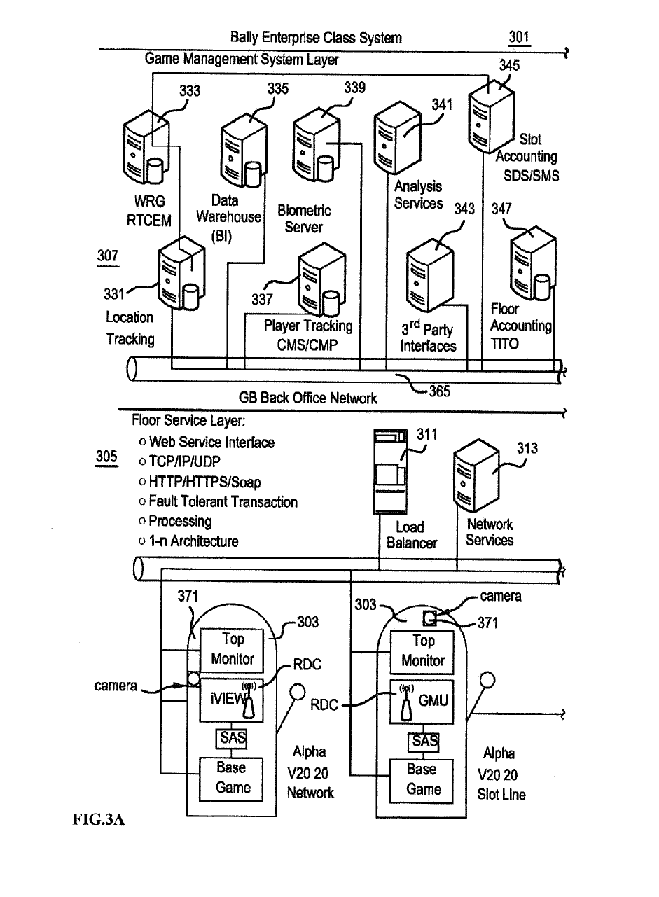

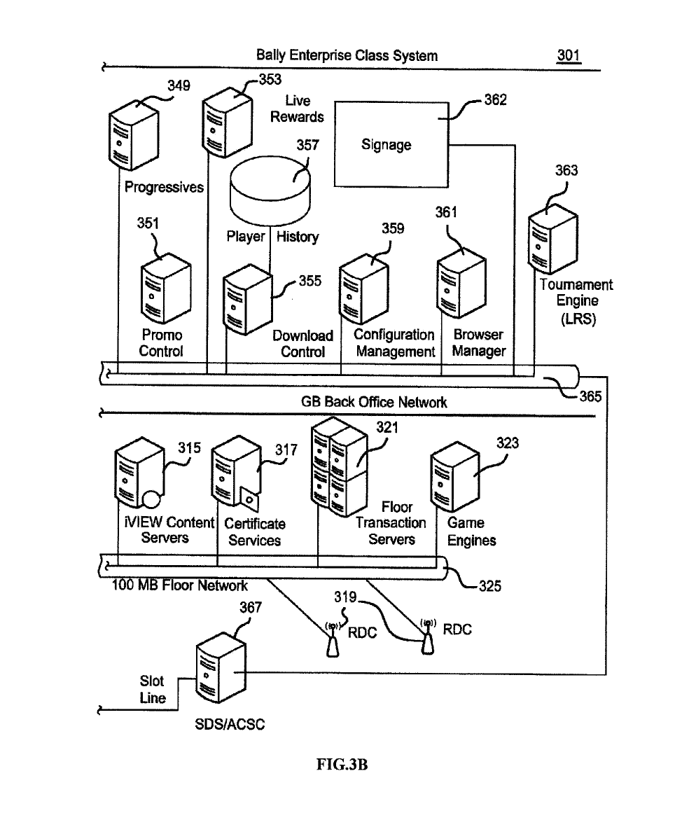

Referring to FIGS. 3A and B, enterprise gaming system 301 is shown in accordance with one or more embodiments. Enterprise gaming system 301 may include one casino or multiple locations and generally includes a network of gaming machines 303, floor management system (SMS) 305, and casino management system (CMS) 307. SMS 305 may include load balancer 311, network services servers 313, player interface (iView) content servers 315, certificate services server 317, floor radio dispatch receiver/transmitters (RDC) 319 floor transaction servers 321, game engines 323, each of which may connect over network bus 325 to gaming machines 303. CMS 307 may include location tracking server 331, WRG RTCEM server 333, data warehouse server 335, player tracking server 337, biometric server 339, analysis services server 341, third party interface server 343, slot accounting server 345, floor accounting server 347, progressives server 349, promo control server 351, bonus game (such as Bally Live Rewards) server 353, download control server 355, player history database 357, configuration management server 359, browser manager 361, tournament engine server 363 connecting through bus 365 to server host 367 and gaming machines 303. The various servers and gaming machines 303 may connect to the network with various conventional network connections (such as USB, serial, parallel, RS485, Ethernet connections). Additional servers which may be incorporated with CMS 307 include a responsible gaming limit server (not shown), advertisement server (not shown), and a control station server (not shown) where an operator or authorized personnel may select options and input new programming to adjust each of the respective servers and gaming machines 303. SMS 305 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 303 include various peripheral components that may be connected with USB, serial, parallel, RS485, Ethernet devices/architectures to the system components within the respective gaming machine. The GMU has a connection to the base game through a serial SAS connection. The system components in the gaming cabinet are connected to the servers using HTTPs over Ethernet. Using CMS 307 and/or SMS 305 servers and devices, firmware, media, operating systems, and configurations may be downloaded to the system components of respective gaming machines for upgrading or managing floor content and offerings in accordance with operator selections or automatically depending upon CMS 307 and SMS 305 master programming. The data and programming updates to gaming machines 303 are authenticated using conventional techniques prior to install on the system components.

After proximity of a patron has been determined by gaming machine 303, player interface (such as Bally iView) (PID) processor may send a signal causing camera 371 to capture an image of a patron. The image may be a facial, retinal, hand, or fingerprint optical image. Alternative imaging technology may be utilized which may capture distinct image signatures, such as infrared or other wavelengths.

The PID processor may send the digitized image to biometric server 339 together with information identifying gaming machine 303 and any additional patron information. For example, if the patron inserted a player card, then player account identification information may be transferred with the biometric data. If the transferred data included player account identification information, then biometric server 339 may access the player account information either directly from its own database or from a player account database maintained by player tracking server 337. If the patron's biometric data has been associated with the patron's player account then the identity of the patron may be verified with the biometric data sent by gaming machine 303 by using a digital filter detection algorithm to determine if the transferred digital biometric data matches the stored biometric data. Biometric server may then send a message to gaming machine 303 either granting or denying access to the player tracking account based on the results of the matching analysis.

If the patron's biometric data has not been previously associated, biometric server may send a signal to gaming machine 303 requesting the patron to verify identity by entering the PIN number associated with the player card account. Responsive to the query, the patron may enter the PIN and PID processor may transfer the PIN information for verification by player tracking server 337. Upon verification of the identity of the patron with the PIN and player card, then the biometric data may be associated with the patron account. Thereafter, CMS 307 may utilize the PIN and/or the biometric data associated with the player account to verify the player's identity at gaming machine 303.

In the case of an anonymous patron, such as a patron who has not inserted a player card, the captured biometric data may be compared by biometric server with a database of both known and unknown patrons whose biometric data has been previously stored. In the event that a match is found amongst anonymous patrons then the associated anonymous account may be updated according to the patron's play on gaming machine 303.

In one or more embodiments, the image capture process may be programmed through the player interface (such as Bally iView) processor to occur continuously on a frame by frame basis at a pre-determined rate. In one or more embodiments, the camera may be triggered by a proximity detection signal which may be part of the camera circuitry or may be separately determined using proximity detection circuitry. Consecutive images may be compared in order to identify a good image. Alternatively, digital filtering estimation and/or enhancement algorithms may operate on the images to determine or generate an image that has a predetermined level of goodness or clarity or meets predetermined threshold minimums, such as distance between eyes or distance between ears, forehead to chin, and so forth. This analysis may be performed by PID processor and once an image is identified as good, then the image data may be transferred to biometric server 339 for comparative analysis with one or more stored biometric databases. The base algorithm that may be used is:

C=HX where H=E{S}²/[E{S}²+E{N}²]

Consecutive images may be operated upon and or an iterative process may be implemented to obtain a good image estimate of the current patron. The filtering discussed herein may be performed using adaptive or classical digital algorithms, and may alternatively be performed using active filters. A more thorough development of the matching and enhancement techniques contemplated herein may be found in the Adaptive & Digital Signal Processing and Active Network Design text books, by Dr. Claude S. Lindquist and related published papers, and are hereby incorporated by reference.

As discussed above, the proximity and image capture devices may connect directly with the EGM Processor Board, GMU, or special purpose IC processor board to carry out the processes discussed herein with respect to the PID processor and board. This may be in alternative to or in addition to the connections with the PID processor board. If the connections are in addition to the connection to the PID processor board, then there may be designated assignments apportioned amongst the boards to carry out the detection and analysis processes, or there may be redundant detections and analyses used to obtain greater confidence in the received and analyzed signals and the comparative analyses used to identify a patron and/or patron activity.

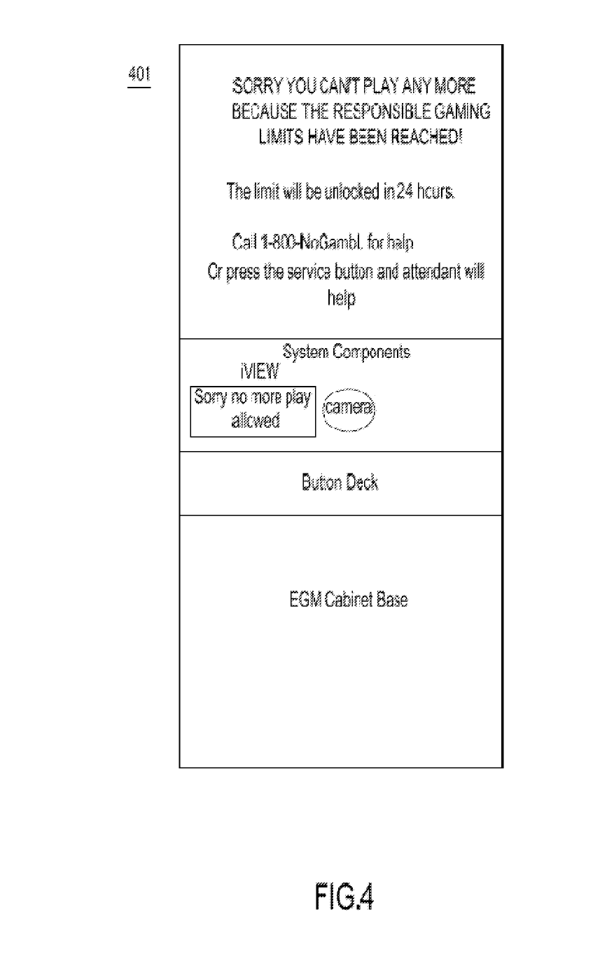

Referring to FIG. 4, gaming machine 401 is shown disabled for play in accordance with one or more embodiments. Disabled gaming machine 401 represents an application that may be performed utilizing biometric data. An anonymous or known player has reached the responsible gaming limits and game processor has generated a message that gaming machine 401 has been disabled and the patron can no longer continue to play. Both the iVIEW screen and Base game monitor screen can show this message. The camera is shown. The anonymous player has been identified with the system camera shown. Associated with the patron's anonymous or known account, a limit may be established for play over a period of time, such as $1000 over a 24 hour period. Once the patron has reached the limit after play at one or more gaming machines 401, then any other gaming machine 401 will lock if the patron tries to play at one or more other gaming machines, since each gaming machine may capture the patron's biometric data, transmit the data to the biometric server, and once the biometric server identifies the patron's account and reads that the player has reached the patron's playing limit, the biometric server may transmit a command to the gaming machine causing the gaming machine to lock until the patron leaves the detectable proximity perimeter of the gaming machine.

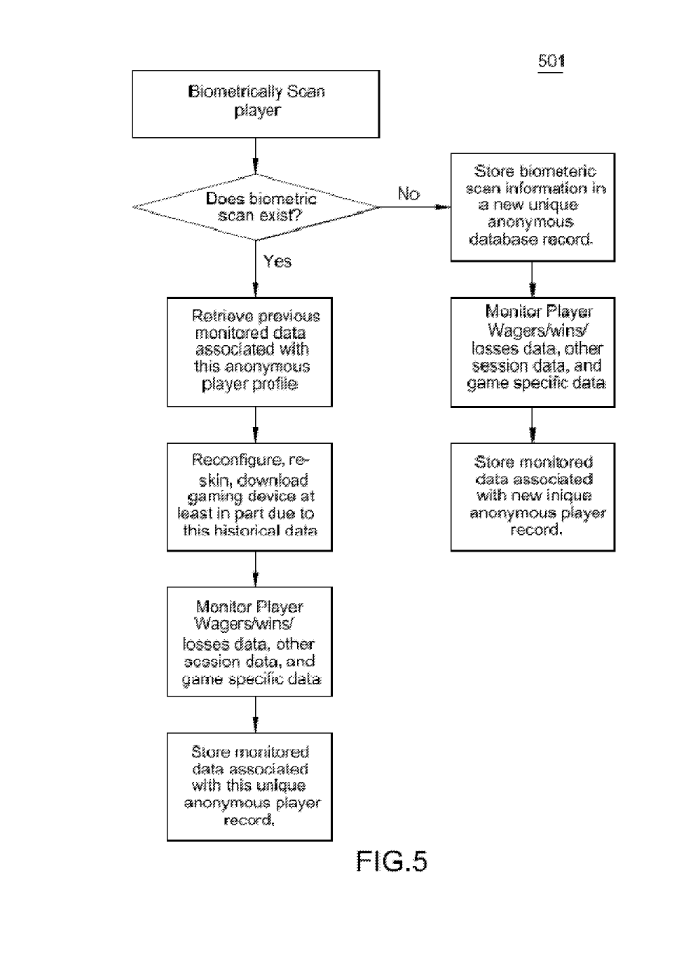

Referring to FIG. 5, biometric flowchart 501 is shown in accordance with one or more embodiments wherein an anonymous player centric reconfiguration/re-skin/download of a gaming device or server based gaming system is initiated based upon past game play wager/win/loss history, session history, game ID information.

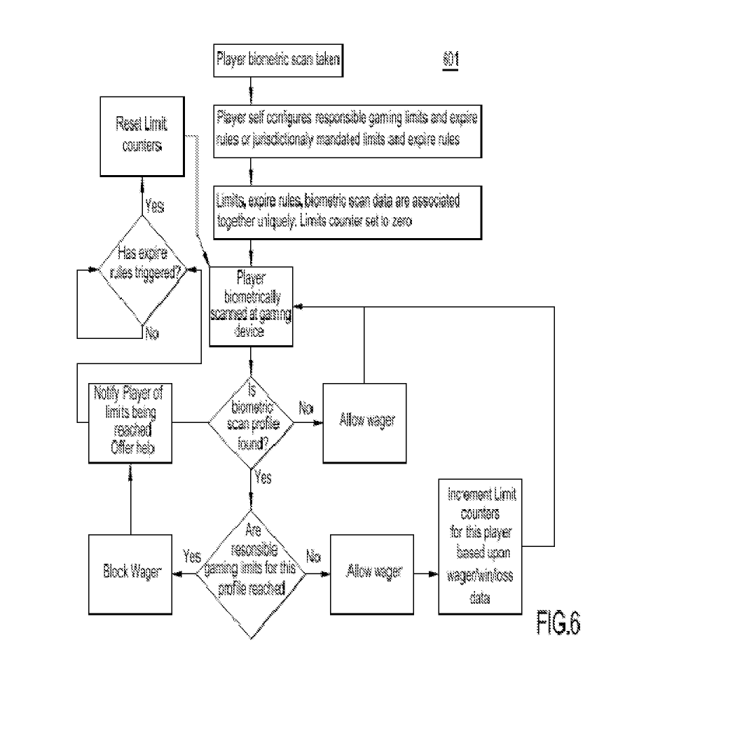

Referring to FIG. 6, responsible gaming flowchart 601 is shown in accordance with one or more embodiments wherein an anonymous player is able to initiate self exclusion responsibility on a gaming system. The player can self limit him/herself or the jurisdictional rules would govern the limits. The player may configure how much he wants to be allowed to gamble per unit time. Once these limits are reached by an anonymous player playing on a gaming device connected to the central anonymous player biometric identification system and responsible gaming limit system then the wagering is blocked at the gaming device. Bill acceptors, currency acceptors are disabled. Player is notified of the limit being reached. Play is blocked until expire rules have cleared the increment limit counters associated with this biometric scan. A cash out occurs with any remaining credits on the gaming device.

General Principles of Operation:
1. An anonymous play session may be defined as the time from which the gaming device is credited (or activated) until the gaming device is either cashed-out or the credit meter reaches zero and no additional credits are added to the gaming machine with a pre-determined time-out period of time, such as one minute. If for some reason the biometric data cannot be acquired at the gaming machine, the session will not be created. In such case, the gaming machine may automatically lock and/or a signal may be transmitted requesting assistance from a floor manager or attendant.
2. A player's anonymous record will be created based upon the first receipt of unique biometric data by the CMS. Subsequent play sessions will be matched based upon the biometric data. The results of the subsequent sessions will be linked to the player's master record. Each session will be tracked uniquely but it will be possible to roll-up all activity (summarize or maintain totals) over a given time period for a given player. When pre-specified gaming levels for a player are detected, a signal may be generated which may include notifying an operator and/or locking the gaming machine if limits have been established and stored on the gaming system.

In principle, the basic flow of information will be as follows:
1. The biometric device will identify the player at the point the device being played is credited in some fashion. The means by which a device is credited could be via cash, ticket, coupon or cashless transfer.
2. The digitized representation of the player biometric information as acquired by the biometric device in use may be transmitted to the network interface onboard the game machine, such as a commercially available Bally Game Monitoring Unit (GMU).
3. The GMU will transmit the data over the network for receipt by a designated biometric data server which may be part of a casino management system, such as a commercially available Bally SDS/CMS. In the event of an anonymous player, the data will be flagged with the fact that the transmitted information is anonymous player identification rather than a standard player tracking message using a card.
4. The biometric data server may create a new player master record if it is the first time the biometric data has been exposed to the system. A new play session will be created and linked to the master player record. The new play session may be a record created by the biometric data server, a player tracking server, or any other designated server with an executable play session record creating software routine. For the purpose of this example description, the play session records and updates are created and maintained by the biometric data server.
5. Periodic updates to the play session may be sent to the biometric data server if desired based on system configuration.
6. When the player cashes out or the credit meter on the device reaches zero, the play session will be closed. The final results of the session will be transmitted to the biometric data server.
7. Final results for the play session will be stored in the biometric data server database. It will be possible to retrieve those results at a later time via tracking reports or through a CMS user interface, such as a commercially available Bally Control Panel with an executable software routine for generating player tracking reports. In addition to routine reports, alerts may be generated at the control panel from either individual gaming machines or from a biometric and/or player tracking server when predetermined thresholds are identified. For example, in the event where the image of an anonymous patron is not found to match an existing image in the biometric databases, then coding may be placed on one or more of the gaming machine, biometric server, and/or player tracking server directing that a signal be sent to the control panel providing the gaming machine identification and a ‘new customer’ notification. By example, the control panel may display icons for each gaming machine on the floor, and the new customer notification may cause the control panel processor to generate a flashing icon and new customer flag on the display which an operator may view and elect to send a message to a floor person identifying the gaming machine and that a new customer is at the gaming machine whereupon the floor person may greet the patron and invite the patron to sign up for a playing card and possibly provide an incentive such as promotional credits which may be placed on the new player account associated with the playing card. Similarly, a message may be sent to the control panel when any anonymous patron begins play at a gaming machine whereupon an operator at the control panel may request a ceiling camera in the vicinity to zoom in on the patron so that a visual identification may be made, such as to determine if the patron may be a minor. In addition, when a biometric analysis is performed of a patron with a player card and the analysis does not match, then an alert signal may be sent to the control panel so that further action may be determined by the operator, such as requesting a floor person to greet the patron and ask for identification.

The biometrically linked data record process may include the following steps:
1. Acquisition of a player's biometric identity at a gaming device. This may occur periodically to enable continuous or successive identity verification during a gaming session at the gaming device.
2. Creation of the player's anonymous record in the CMS/CMP, if the player has not inserted the player's card into the gaming device or otherwise provided machine-readable identification. In the event that biometric data has been inputted with respect to a particular player and player tracking account, then the acquired biometric data at the gaming device may be compared with a player database to identify the player and the respective player tracking account.
3. Accumulation of the player's activities during a gaming session on the gaming device.
4. Termination of the gaming session upon player cashout or when the gaming device credit meter reaches zero or a period of gaming machine inactivity or the biometric identity is no longer available or read by the biometric reader.
5. Creation of additional play sessions for the player at a second gaming device (or by adding credits to the original gaming device). In the event that the player is anonymous, then the acquired biometric data from the one or more additional play sessions may be used to compare against a database of anonymous players biometrics, identify the player's record/s and associate any additional records.
6. Linking first and second play sessions to the same anonymous record in the CMS/CMP.
7. Review of activity via reporting or user interface on the CMS

Referring again to FIGS. 1 and 2A and B, inside each gaming device or attached thereon is an analog or digital camera which may capture still and/or video images. If an analog video camera is used then the video signal is taken out of each gaming machine to an analog video hub hidden in the base of one of the gaming machines in each bank. This multi-port analog video switch has digitization means to capture each incoming video stream and convert to digital video data stream that can be carried over gigabit Ethernet wire to a central network operations center. Manufacturers of this type of device include: Winnov who makes the XstreamEngine2 product which is the latest generation of turnkey encoding systems designed by Winnov. XstreamEngine2 systems capture, encode, archive, and broadcast audio and video. By example, a camera device may provide two web based remote control interfaces, DRX and MRX. DRX may comprise a full featured, general purpose remote interface, such that a DRX interface enables configuration, control, and monitoring. The DRX interface may further provide a real-time remote audio and video previewing feature. The MRX interface may be designed for use with portable devices and provide for management in the field. Both, the DRX and MRX interface may provide multi-system, multi-stream control. The multi-port analog video switch box may digitize and transmit all video stream feeds from each of the gaming machines to the server over a single Ethernet wire or it can be controlled by a central server to send only one video feed at a time from the bank of EGMs to the network operations center. Each video stream channel may have an associated EGM ID with it in a database. A security surveillance system center can directly feed these video stream feeds for viewing on there security monitors. The security staff may be provided with a control panel to switch between multiple feeds and their associated EGM IDs. Multiple video feeds for multiple EGM's can be displayed on a single security monitor screen. The security staff can selectively direct the digital video feed for any specific EGM to the biometric application server/database to scan the video feed and identify key facial biometric features, and then search for a match in an anonymous player biometric database. A comparison to a biometric database of previously registered players associated with a casino patron number can also be done. If a match is found then the historical play/attendance record of the individual can be shown to security staff. The security staff can also look for players who are banned from the casino property. This video feed and associated player data can be sent to overhead signage throughout the casino property and in other casino properties at key events that occur on the gaming machine not limited to jackpots, tournaments being run, competitive events like group play bonus rounds, hand pay events and the like. This same video capability can be given to the marketing staff, the slot director staff, the property management staff, the beverage staff, etc.

In alternate embodiments the digitization of the video feed or still camera image can occur within the gaming device or within the camera itself and the data transmitted over the network. For example, a USB digital video camera can be plugged into the GMU, the iVIEW or the EGM processor board directly. Alternatively, a USB-to-Ethernet converter or an Ethernet camera could allow the video stream to be directly sent to the server without encumbering or providing overhead to the gaming machine processor boards. The IP based camera can be directly IP addressable, so any server can tap into its feed. The IP address of each IP camera may be linked to a respective EGM ID for a gaming device and its associated IP address. The entire digital still image, images, or video stream can be sent to the server over Ethernet wire that services the electronic gaming device as well. There would be multiple protocols and messages running over the same Ethernet wire to the same server or each to different processing application servers. This allows the VPN that is attached to each gaming machine to be used for this video camera/biometric recognition system as well as for carrying gaming protocol messages, such as G2S, Slot Data System SDS, SMS, Live Rewards, Browser, HTTP POST and GET messages. In one embodiment, all of the data from a given gaming device is transferred over one wire to a network operations center, such as a host server for a CMS, so all of the gaming device data and video stream data transmitted over the wire may be associated with the Ethernet address for the EGM. Thus there can be a direct correlation of the video stream/video capture image to the EGM ID. This may allow all EGM events to be linked to specific video feeds.

If a security surveillance application is not used, the video stream or still image data from each EGM can be sent directly to the biometric application server/database for comparison to stored biometric hashes, patterns or images. If the comparison fails, then the server may create a new anonymous biometric account ID and associatively store the biometric hash or facial pattern. Once an anonymous player account has been established, the operator may track the player's wagers, establish a player rating, provide incentives for play, enable eligibility for bonuses which might otherwise be limited only to players with player cards inserted in their respective gaming machine, and offer other features that may be available to a registered player with a player card and account.

If the biometric comparison by the biometric data server identifies a match, then the current anonymous play session activity may be linked to the previous anonymous player account and the anonymous player's associated play history. Player rating, bonusing, and other features would then occur for this return player as described herein.

In an example embodiment, there is a biometric processing system associated with networked electronic gaming machines. As contemplated in an example embodiment, a networked gaming system includes a host computer connected through a network backbone to a set of gaming machines on a casino gaming floor. It is contemplated that each of the gaming machines include a biometric imager, such as a camera which may be attached to the front panel of a Bally iView as shown in FIG. 1. The biometric imager may include an image digitizer for generating a digitized biometric image of a patron that initiates activity at a selected gaming machine. Each gaming machine may include a transmitter to transmit the digitized biometric image to the host computer as through a network interface, such as a Bally GMU. The host computer may connect to one or more servers and databases which may perform various functions. One of either the host computer or a designated server may receive that transmitted digitized biometric images from the various gaming machines and maintain a database of archived biometric data in accordance with an executable biometric data receive, record and analyze program. The designated biometric data server may include a digitized image comparator for comparing received digitized biometric images with the archived biometric data. In the event of a match, the biometric data server may initiate a series of steps, such as creating a gaming session for the player at the gaming machine, associating the gaming session with past gaming sessions by the same patron, receiving and associating playing data for the gaming session, accumulating points for the current gaming session and combining them with the prior gaming sessions for potential player awards, and establishing eligibility of the player for bonuses.

The biometric data server may include programming to generate and maintain databases concerning patrons which may include biometric images. In addition to the data associated with a patron may be a rule or instruction that may be triggered when the host computer or one of the processing units, such as servers or user control stations, receives a biometric image from a gaming machine, executes a matching algorithm to compare images in the databases with the received biometric image, and finds a match. Various conventional digital signal processing or image processing algorithms may be easily adapted to execute this process. As indicated the match searching algorithms may be automated to execute upon the receipt of each received biometric image by the host computer or one of the affiliated processing devices. The databases may be established and maintained for many different purposes including player rewards, restricting play, or identifying criminal activity. For example, while carded players may be identified by inserting their card into a gaming machine, uncarded players may not so easily be identified and rewarded. So, one database might be developed for uncarded players so that their playing habits may be stored and rewards associated with their play can be generated based on a biometric match. In which case, an instruction may be set to send the player a reward upon meeting a threshold level of play which may be on the current session or cumulative. Another database may store data of banned players, so that if there is a match then one or more signals could be sent from the host computer to the gaming machine causing the gaming machine to cease operations and to signal an attendant to go to the gaming machine to escort the patron away from the gaming area. Similarly, databases may be set up and maintained of players with problem gaming issues, so that their play may be restricted to pre-specified limits. Another database may maintain information about game play that may be identified as potential money laundering or fraudulent ticket usage, in which case the biometric image would be used to identify a perpetrator and to cause various actions to occur, such as sending security or calling the police, etc.

In one embodiment, the gaming machine is re-configured, re-skinned, and optionally downloaded to, based upon the anonymous identification data achieved without positive player interaction with the gaming machine or biometric input reader. The offer engines, advertising servers, download and configuration system, Casino Management Systems (such as Bally CMP/CMS) and Slot Management Systems (such as Bally SMS/SDS), Bonusing servers (such as a Bally Power Winners server) can be all integrated and may determine and set the gaming machine configuration specific to this anonymous biometric sample taken. The unique biometric sample taken can be linked to a Casino Management System anonymous account record. This CMS/CMP account will track past game play history from multiple sessions and user preferences. This anonymous account record is created solely with the anonymous biometric data as a unique identifier of a player. No user name, address, contract info or player demographic data is collected prior to the biometric scan occurring at the gaming device. In effect a unique player identity has been created in the CMP/CMS player tracking databases even though the player has never taken positive action to register at a players club desk or kiosk.

In an example embodiment the gaming software executes on a Server-based Gaming server and is reconfigured or downloaded at the based upon prior preferences associated with the anonymous player identity and stored on the biometric server database. The game display presentation and the user interface is provided to the player by example, through a gaming portal apparatus, a browser based gaming device, a smart client gaming device, or a thin client gaming device. These Server Based or server supported game systems have the outcome determined at the server. The player is notified at the client user interface of any wins. The player can select the wager size at the client user interface device, such as a button deck, mouse, keyboard, or touch screen.

In one embodiment the reconfiguring or download to the gaming device can be based upon this anonymous facial or other biometric recognition system based upon the demographic data collected by the biometric input device in association with a gaming device. Non-limiting examples include: an older person may have the game modified to make the reading of the game content easier by magnifying the displayed content and/or adjusting the lighting or color contrasts; people with a certain color of skin, hair, or eyes may show some statistical preference of modifying a selected game or gaming device; the language that a player speaks can be used to localize the gaming content shown onscreen to that player through the use of voice recognition software; the sex of the person can be used to change the color and theme of the game or otherwise reconfigure the gaming device; prominent facial features, body types, can also be used to reconfigure, download, or re-skin the gaming device. Combinations of various demographic data types derived from the biometric sample can force different reconfigurations, re-skins, and download of the gaming device, either automatically or by offering an available option to a player. This demographic data determined by the image and facial recognition software could be further used to identify the specific player from a list of players. If the facial recognition system matched the coordinates of the eyes, nose and other features against two or more similar patterns in the database, then the demographic data may be used to further associate the patron with an identified group. Thus the color of the skin, eyes or other features can be used to further identify likely player preferences, in addition to the coordinates of the major features of the face.

In an example embodiment, advertising or game offers are shown and are viewable on a gaming device display to a player or an observer in close proximity to the game driven and controlled by the demographics of the person being scanned by the facial recognition software, camera, or other biometric reader in association with the gaming device. These offers will encourage a player to play by giving the player the types of games that are typically preferred by this demographic group. One or more advertisements may offer a better game if the player initiates play on the gaming device in accordance with a prompt.

In an example embodiment, a biometric identification system networked through a gaming machine, allows the player to sit down at a gaming machine without identifying himself/herself through the use of a traditional player card or other identification means, be initially identified through biometric identification, and be subsequently re-identified during a gaming session by anonymous identification means using a facial recognition system or other biometric input technology. As one of the features of the biometric system, the gaming machine can be reconfigured into a mode appropriate for this anonymous player based on the biometric identification and either past identified player preferences or associated group playing preferences. Better games, different games, different game combos, player preferred games, the game that the player is luckiest on, recently played games, and so on can be configured, re-skinned or themed, or downloaded to the gaming device or server-based gaming engine once such anonymous identification is achieved. The player may be notified of such changes on the video screen or the reconfiguration may take place without notification to the player or the player may be prompted to request the offered reconfiguration. Such a device and system and method allows for a completely player-centric reconfigurable gaming system, device, and methods even though the player has not previously and in person created a named player patron account in a traditional casino player tracking system.

In one embodiment the player may anonymously biometrically identify him/herself with a finger print reader as shown in FIG. 1 on the player tracking front panel. Once this scan is compared to the anonymous player database of other biometric scans and its associated unique player tracking database record, the gaming device can be re-configured, re-skinned, or downloaded to player preferences, to a recently saved game state from a recent gaming session. Player session rating and bonusing would occur for this anonymous player based solely on this unique biometric sample and the newly reconfigured gaming device. In this case the player takes a positive action to scan his/her finger on the fingerprint reader. He/she would be told that this identification will give a better bonus and gaming experience, so the user is encouraged to do it. This player would still be anonymous to any systems meaning the player name, address, contact info is not known to the central CMP/CMS player tracking system. Only the biometric scan/hash is stored for this session and linked to the same scan/hash from previous game sessions for the purpose of bonusing and automatic game reconfiguration and/or download.

A gaming session for a player may be defined to end on the occurrence of one or more events, such as when the machines credits are set to zero and additional credits are not added within a first predetermined period of time, the player cashes out, the player leaves the gaming machine for a second predetermined period of time, there is inactivity on the gaming device for a third predetermined period of time, or, the gaming device or gaming system prevents further game play, such as when a gaming limit has been reached for the player or when suspicious behavior has been detected. The predetermined periods of time may be selectable by an operator and may be the same or different periods of time, such as a period of one minute for each predetermined period. Additionally or alternatively, the periods may be preset by the gaming device or gaming system manufacturer. In one or more embodiments, the settings may be input over a network from a server station remote from the gaming device. In one or more embodiments the predetermined periods may be input directly at the gaming device.

This anonymous biometric scan has an advantage for the patron because he/she can remain anonymous to the world, but can get the benefit of the player centric reconfigurable gaming device tailored to his past history of play, and his/her player preferences, and demographic profile. For tax reasons and other privacy reasons the player may not want to have a player tracking card that associates all gaming sessions' wagers and wins together. Different state lottery or other government commissions or regulators may want to allow the player centric-reconfigurable gaming systems but do not want to have a player name and contact info database due to the freedom of information act. This player name and wager/win/loss data could become known to the public through the press or private citizens who request the data through the freedom of information act. This anonymous identification of the player allows for the state lottery to deliver a reconfigurable gaming system competitive to the private gaming properties such as in the class III Nevada jurisdiction.

In one embodiment a hand vein detection system is used to anonymously detect the unique pattern of veins in a player's hand. In one non-limiting example, this vein detection system is usually placed above the spin button on the gaming device. So as each spin or play button is pressed and a wager is committed the scan is done. This can be continually or periodically done to ensure the same player is still playing the gaming device. The player rating session would continue while the same player is playing. In an example embodiment, a vein detection system uses an invisible IR illumination and camera system to anonymously identify a patron and the system may be done without the player's knowledge. This technology can be used to as an aid to age verification systems in an identified player in a casino player/biometric database. Play is blocked on the gaming device or notification to casino authorities is sent if the hand vein scan is someone not in the registry of approved hand biometric scans.

In one embodiment, the casino management system may biometrically identify a new anonymous player playing a gaming device and dispatch software may notify casino club desk employees that a new anonymous patron is playing. The casino operator may then send an employee to greet the new patron and issue a traditional player card, so the person can use this player card if they so choose. The player card number and the biometric scan data are uniquely associated together, so on subsequent visits the patron can use either one or both of the player card or biometric scan. Either way the player session data is maintained for this player spanning multiple sessions independent of how the player was identified.

In an example embodiment, a responsible gaming system, method, and device are disclosed. A player may be provided a user interface at a gaming machine, kiosk, player's club desk or other registration device or site to configure gaming self-exclusion rules for his/her facial or other biometric scan pattern or hash. The player may set up the gambling limits including but not limited to: wager limits, win/loss limits, loss rate per unit time limits, time on device (session time) limits. In other embodiments these limits may be jurisdictionally set, and a player can only view the limits configured for this jurisdiction and the current player advancement towards these limits from monitoring play on the gaming device. A player can also set self imposed threshold limits under the state or jurisdictional required limits. The player can set the expire rules for these self imposed limits. A non-limiting example is to not allow more than $500 of wagering in 2 hours of time then play is blocked. The wager limit may expire after a preset amount of time of no wagering by the player. This invention forms the basis for a player to self-exclude himself/herself from gambling if these limits are reached. If this non-identified player begins a play session at a gaming device and his/her facial or biometric pattern is matched to the central biometric database then the jurisdictional and the self exclusion limits are checked. If the player has reached any of the self exclude limits then the play on the gaming device is blocked. The bill acceptor, ticket acceptor, coin acceptor, electronic funds transfers are all blocked from use on this gaming device. The player will be cashed out and a ticket will be printed for any remaining credits on the gaming device. The player will be notified of the limit being reached on the gaming device screen or player tracking display (iVIEW) on the gaming device. Once the expire rules have occurred on these limits play can resume on this or another gaming machine in this and other properties configured in this system.

In another embodiment this responsible gaming system may also be used with a traditionally identified patron who has chosen to not play with the players club card. The player clubs card account number and the biometric scan data are previously associated together. Whenever the player uses one or both identification means (club card or biometric sample) then the session wager win/loss data is monitored. When the responsible gaming limits are reached by this player then play is blocked as previously disclosed. Expire rules would clear these limits automatically and wagering could resume.

In one embodiment, a money-laundering detection system associated with a gaming machine is disclosed. Money laundering is when money from illicit sources (drugs, mob, FBI or treasury marked money, fake money, or other) is cleaned through the gaming machine. The machine can take this dirty money in to its currency acceptor and converted into an electronic credit. It can then be subsequently cashed out, and a ticket or cash/coin dispenser would issue clean money or ticket out to the player. The money laundering player had no intention to gamble, but the intention was to rather scrub the money clean. The dirty money is left to the casino or gaming location to deliver to its bank or other patrons after it does a cashbox drop. When a cash ticket is issued from a gaming machine then the money laundering person takes the ticket to the cashier for redemption and conversion into actual cash that was different from the cash inserted into the gaming device. Currency input devices and their associated gaming device can be monitored for out of bounds conditions. This means that a certain amount of money has been put into the gaming device and onto its credit meter, and then the player immediately cashes out or plays a few games of insignificant wager amount, and then cashes out a short time thereafter. These out of bounds conditions can be configured by central systems. Gaming machines or their currency acceptors are monitored for these out of bounds conditions being triggered. This determination can be done by the gaming device, its attached system components (GMU, iVIEW), or central out of bounds checking servers. Once an out of bounds condition has been determined then the facial recognition system can scan the players face and record the event in the system. Alternatively the facial recognition system or camera can photograph or biometrically identify each anonymous player who is depositing currency, wagering, and withdrawing currency. This data can be stored in a database for later retrieval and an audit trail for security personnel or authorities. The facial biometric data or image scanned is stored with the out of bounds data of recent credits, wagers, cash outs on the gaming device. Alerts to security personnel or other location personnel can be done to notify that there is a problem with this type of out of bounds transaction. Notification of this may be given on the gaming machine display or its iVIEW player tracking display. The facial pattern or biometric scan can be compared to others patterns in the out of bounds database and linked together.

In an aspect of this embodiment, the facial or other biometric system can anonymously scan the player of the electronic game machine and this data can be sent to the out of bounds server to see if there were any previous out of bounds conditions reached for this biometric pattern. Once a certain amount of these out of bounds events have occurred in total or in a specific amount of time on the same or different gaming machines then authorities would be notified, and biometric data would be provided to these authorities for prosecution purposes.

In still another embodiment, a distributed surveillance security system is provided in conjunction with an electronic gaming device. Each gaming device would have a facial recognition camera system integrated with the gaming device. This system would enable security personnel, auditors, regulators, authorities to monitor who is gaming at any specific gaming machine in a single property or a group of gaming locations. Each credit applied to the gaming machine, each wager, each win, each loss, and a cash out or funds transfer to a player account, activity can be monitored and linked to the surveillance photo or video of the player who did the event. A non-limiting example: the image or biometric sample of the winner at the time of a jackpot can be stored for later reference and validation of who actually triggered the jackpot. This would solve disputes as to actually who won when two or more players say they won the jackpot. Integration of this surveillance system with the Game Monitoring Unit or IVIEW contained within the gaming device can trigger these picture or biometric scans when certain metered events (not limited to jackpots, out of bounds conditions) are triggered on the gaming device. Casino security surveillance systems integrate into the camera inside the gaming cabinet. Thus the casino can get a good close-up image of the patron playing the gaming device at any instance in real-time. They can use this data to compare against a database of banned players. If a banned player is found then play can be blocked on the gaming device by sending a disable command to the gaming device. Security staff can be sent to the specific patron to escort him/herself out of the property or turn the patron over to authorities. This surveillance system tied into the gaming device gives the casino security staff an additional 2000 plus surveillance cameras on a traditionally sized casino floor. These cameras are better located to provide a better video capture or still scan of the person playing the gaming device or in proximity to the gaming device then the overhead video camera systems common in casinos. In small locations that can't afford a surveillance system these embedded surveillance systems with the gaming device provide auditability of the gaming transactions, of who is playing, who gained access to the insides of the gaming device, who is loitering around the gaming device, etc. Access to the inside of the gaming cabinet can be blocked through electronic locks, for example, unless the facial pattern is matched against a known approved person database. In the event of a match of an approved person, the electronic lock on the gaming device may then be unlocked. Also the live video feed can be sent to security staff for manual visual approval that the correct slot technician or bill drop person is trying to open the cabinet. The central security station can block the opening of the cabinet if the correct person is not identified. This surveillance system can be used to aid in age verification of the player playing the gaming device. Location attendants can view the people playing gaming devices even if they are not in direct view through the use of attendant video displays. If underage patrons are discovered then the appropriate action can be taken. This system can also be integrated into wireless gaming devices that are traditionally handheld. This system can also be integrated into in-room gaming systems to monitor age of a player of a gaming device in a hotel room. This camera is only active when a wager occurs. This enables casino security staff to monitor the person wagering in locations where traditional surveillance cameras don't exist. An example would be at poolside or in a hotel room. A series of videos or photographs are taken and stored of the player of the gaming device upon each wager, win, or other transaction on the gaming device. The surveillance staff may playback video or still images of each game played one by one to ensure compliance with the casino rules, laws of the state, or other jurisdictional laws. These cameras can deliver a video feed directly to the surveillance system or a video stream over Ethernet networks. The camera can be tightly integrated into the player tracking system components and use the same or different Ethernet wiring and/or wireless technology that may connect the gaming device to a gaming facility's associated servers (Security servers, Slot management, Player Marketing, Bonusing, Facial recognition servers, etc.) The camera can be USB or Ethernet based. Either connection can be provided to the system components (GMU, iVIEW, base game processor board) in the gaming device.

For example, in one specific, non-limiting embodiment, the anonymous facial recognition in association with the gaming device can be used as an age verification tool. The facial scan or other biometric scan can be analyzed for patterns that look like child's typical patterns. Adults and children have significantly different facial features not limited to overall size and spacing of facial features. The differences can be used to block play at the gaming device if the under age features have been identified. Alternatively the casino personnel may be notified that there may be an underage person playing a gaming device and that they should visually or otherwise confirm the player is of required age. This system can also be integrated into wireless gaming devices that are traditionally handheld. This system can also be integrated into in-room gaming systems to monitor age of a player of a gaming device in a hotel room. This camera is typically only active when a wager occurs to maintain privacy of the hotel room. In one example, the person wagering must pre-authorize the capture of his/her image prior to being allowed to play the gaming device (wireless device or traditional gaming device). Otherwise play is blocked on the gaming device.

In still another embodiment, an anonymous player may be identified and confirmed for eligibility in the selection of a bonus award recipient. For example, in one example embodiment, a bonus award may be made by a casino, such as a Bally Power Winner award, to known patrons who are either playing at one of the casino's gaming devices or who have a player card inserted into respective gaming devices that have not timed out. In this example embodiment, a progressive is triggered at a random time. In addition or alternative to the traditional approach of identifying players through player cards, the facial or other biometric recognition system can be used to determine that a player is playing the gaming device and can be added to the pool of possible winners from which one may be chosen randomly or quasi-randomly. If the progressive triggers and a player is determined to be a winner of either a progressive or a consolation prize then the prize can be given to the player at the gaming device through an automatic (AFT) funds transfer to the credit meter or a cash ticket can be printed at the gaming device. The image or identifying indicia of the patron who won the progressive or other jackpot can be printed on the cash voucher. Biometric data may be later used to validate that the prize is given to the correct person at the cashier cage or other redemption site.

In an example embodiment, an anonymous player who has be re-identified as a return player, or as a return player of certain patron level or status based upon past play history, can be bonused or comped based upon this patron level or historical play. A non-limiting example is where a Power Winners progressive is configured for anonymous players who have played over $500 of wagers in the last month. If any of those players sit down and wager in front of the gaming device and the facial recognition system and the CMP/CMS system determines this player meets this criteria then the player is qualified for entry into this progressive bonus if it triggers. In this case, the player who wins the award may or may not have been identified by traditional means with a proper registration of his/her name in the player tracking system.

In one embodiment, once a face of any sort is seen or another type of biometric scan like a finger print is taken and credits are put on the gaming machine then a metered session is started on the gaming device or within the CMP/CMS system. All gaming machine meters including but not limited to: wagers, wins, losses, deposits, and cash outs are monitored. Then a facial or other biometric scan is taken of the player upon player initiating the scan himself or a non-player initiated scan is taken. Once the facial recognition system has identified the face or other biometric sample against the anonymous player database the accrued session data is linked to the central CMS/CMP player rating database. This way the player may be made eligible to receive the entire benefit of the Bonusing the instant they start playing even if they haven't been identified by the anonymous player identification system for a minute or two. When a face leaves the field of view of the camera, the player session meters may be frozen and Bonusing eligibility may be ended for this player and for this gaming session.

In one embodiment, a player may, after previously playing anonymously, register at a player's club desk for a player's card and account by providing identification such as a driver's license and a facial scan. This new scan may be compared to the database of scans of anonymous players and if a match is found then any accumulated points, awards, or Bonusing earned to date may be assigned to this newly created patron ID account. Then the anonymously generated comp data and previous play history will be assigned to this specific patron. The patron may then be given a player card to identify the patron during later player sessions at the EGM's. The facial recognition system may then only have to do a one-one match of the player card to facial recognition data. This is a much quicker look up verses one to many look up of facial or other biometric data to the multitude of anonymous players' facial/biometric data. Other types of biometric scans are considered within the scope of this invention. There are player initiated scans and non-player initiated scans. Player initiated scan require the user to knowingly start the scan process by taking an action and using the biometric reader. Fingerprint readers integrated into the spin button may take a non-player initiated scan of a player. Thus each spin or play the identification of the player can occur whether the player is using a player card or not.

All of Bally's Bonusing products are envisioned to be able to be utilized for anonymous players that have been re-identified this session in the anonymous player database. An anonymous player can be comped and bonused in the same ways as if the person had actually registered for a casino patron ID card account and used this card at the gaming device. The anonymous player will earn his/her Live Rewards bonus games on iVIEW the same way he would if he was a traditionally registered patron of a casino. The anonymous player can move from gaming device to gaming device and his/her virtual or anonymous CMP/CMS patron account can move with the player. The comp's or bonuses accrue over multiple play session once the facial recognition system identifies and matches the player this session to the player who played in previous sessions. These anonymous players can be grouped into different club levels without the player even knowing. For example silver, gold and platinum club levels are traditionally defined for casino registered patrons who hold a magnetic stripe patron card. Players who reach these certain club level status are given extra or different Bonusing based upon these club levels. The anonymous players that can be linked into these same or different club levels without the player even knowing. An anonymous player may advance from one club level to the next based upon wagering activity this session or spanning multiple sessions. This Bonusing to the anonymous player may be further modified by the gaming device being played: its EGM ID, its selected denomination, its game ID, its game combo ID, its location ID, its zone of the floor, the country-state-or local jurisdiction the machine resides in, the property ID, the group of gaming machines this machine belongs, it geographic location, its IP address, other players playing on the same gaming machine. The Bonusing rates for anonymously identified players can be configured by casino personnel in the CMP/CMS player tracking servers.

In one or more embodiments, anonymous or known player ending game state or bonus state feature may be incorporated in a biometric identification and gaming system by storing the game and/or bonus state information in a database associated with the anonymous or known player account and recalling the state information at a later gaming session. Game specific settings, levels, objects, XML data, game variables can be saved in a database and associated with an anonymous player's biometric data and/or account. The biometric sample, biometric hash, or image of a player can create a primary key in a database. These game variables can be saved to the save state server as the player cashes out of the gaming device or leaves the gaming device as determined by the camera or other proximity detectors, such that when the player returns to a gaming device or a gaming device with the same wagering game as previously played then the previous state of the game may be recalled from the system and downloaded to the selected gaming device. The player can also elect to save state manually and store the data referenced to the facial recognition pattern or hash code or other biometric scan or hash. A non-limiting embodiment is a fingerprint reader can be added to the gaming device and the anonymous player can swipe his/her finger on the reader. The game state would be then saved for this player against this biometric sample or hash. The user would come back to the same gaming device or a different gaming device and swipe the finger and the game may be reconfigured to the prior state of the gaming device from the prior gaming session. The player may be given the option before reconfiguration occurs, such as by the gaming device displaying a query on an iView display asking whether the player would like the state of a previous gaming session restored and providing a message that this may take a couple of minutes for the system to search and download the requested prior game state. The game state data may allow for complete recovery of the game state even though the player is a non-identified player. This allows the player to remain anonymous to the casino or site but still have the ability to use the save state capability. This feature may also be programmed to operate with anonymous wireless devices and portal based gaming sites. There are player initiated scans and non-player initiated scans that may be used as part of the save game state/recover game state process.

A biometric sample can be taken of a person who played a tournament game as a means of identifying the anonymous player later at award collection time. This person's tournament score can be stored in the leader board for this tournament and associated with the anonymous biometric sample. If the anonymous player sees his/her score won a tournament prize the player can go to the tournament prize redemption center and present his/her biometric data (fingerprint scan, facial scan or other scan) and collect his/her prize if the current scan matches the scan associated with the tournament prize and score and a winning position on the tournament leader board is determined. The tournament player may also be given a tournament score receipt voucher with or without the scan data, scan hash, or image of the player on printed on the voucher. The image of the winning player may be stored in a central prize database. The player could redeem the voucher for the prize if the attendant determines that the person redeeming the voucher is the person whose picture is on file who earlier posted the tournament score.

In another embodiment the anonymous person can come back to the gaming device and have his/her face or other biometric data scanned to determine if there are any winning tournaments, raffles, bingo games, lottery winnings associated with his biometric sample. If so the player can collect the prize at the gaming device or a kiosk terminal. This technology allows for the redemption of prizes by an anonymous player who purchased or was freely given an entry into a game that awards prizes after a player concludes his/her gaming session. The anonymous player image or biometric sample that is generated before, during or after the game is associated with the tournament score entry, lottery numbers or any other unique identifier for the game being played. The anonymous player can redeem for the prize with the biometric sample only or in conjunction with other identification means not limit to a voucher with tournament scores, game entry number, raffle numbers, lottery numbers, sweepstakes numbers and the like printed thereon.

In one embodiment an abandoned card is determined using the traditional player card reader and a Game monitoring unit. If wagers have not occurred for a period of time the GMU creates an abandoned card transaction. The card reader and iVIEW display show that an abandoned card event has occurred. If the patron leaves the gaming device with the player card still in the card reader, then a lost card has occurred. Another player may come to this same gaming machine and re-insert this player card in an attempt to use this player card as his/her own. The facial recognition system could scan the players face and compare to a facial scan of the authorized patron for this player card. If the scan doesn't match then an event can be sent to security staff. A video or still image can be taken of person attempting to use the card fraudulently. This can be used as an audit record and be provided to security staff or authorities to aid in prevention and prosecution of fraudulent player card use.

While the example embodiments have been described with relation to a gaming environment, it will be appreciated that the above concepts can also be used in various non-gaming environments. For example, such rewards can be used in conjunction with purchasing products, e.g., gasoline or groceries, associated with vending machines, used with mobile devices or any other form of electronic communications. Accordingly, the disclosure should not be limited strictly to gaming or arcades or to portal based game sites.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A system for uses of first devices communicating over a network to at least one remote first server where said first devices are configured to interface through electronic communication with a second device, said second device enabling access to a second server with data associated with one or more of chargeable account, password and biometric information; said system comprising:
said at least one remote first server storing user account data including (i) biometric image data for identified users and unidentified, established anonymous users and (ii) data associated with one or more of chargeable account, password and biometric information associated with said second server;
one or more biometric sensors associated with said first devices to acquire biometric image data of a substantially unique biometric feature of a user, one of said sensors or first devices configured to provide the biometric image data to the first server through said network;
one of said first or second devices configured for determination of the geographic location of the device and providing data corresponding to said location to said first server;
said first server configured to receive from said first devices (i) account information from said second server via said electronic communication between said first device and said second device, (ii) match the acquired biometric image data with a biometric image data stored at one or more of said first server and said second server, if a match is made (iii) associate a user with an identified user account at one or more of said first server and said second server or an established anonymous player account at said first server to provide access thereto or in the event a match is not made to (iv) establish a new anonymous user account at said first server and associate said acquired biometric image data for said user who cannot be identified and data from said second server with said new anonymous user account and provide access thereto.

2. The system of claim 1 comprising said second device is a cellular telephone and said electronic communication is near-field communication.

3. The system of claim 1 comprising said first server configured to charge against said chargeable account for gaming.

4. The system of claim 1 wherein use is subject to a geographic area restriction, said system comprising said first server is configured to determine if said first device is located in said geographic area and if so to enable said first device for use and if not to disable said first device.

5. A system for players of gaming devices communicating over a first network to at least one remote gaming server where said gaming devices are configured to interface through electronic communication with a second device, said second device enabling access to a non-gaming account server with data associated with one or more of chargeable account, password and biometric information; said system comprising:
said at least one remote gaming server storing player gaming account data including (i) biometric image data for identified players and unidentified, established anonymous players and (ii) data associated with one or more of chargeable account, password and biometric information associated with said second server;
one or more biometric sensors associated with said gaming devices to acquire biometric image data of a substantially unique biometric feature of a player, one of said sensors or gaming devices configured to provide the biometric image data to the at least one gaming server through said first network;
at least one said gaming and second devices configured for determination of the geographic location of the gaming device and providing data corresponding to said location to said at least one gaming server;
said at least one gaming server configured to receive from said gaming devices (i) account information from said non-gaming server via said electronic communication between said gaming device and said second device, (ii) match the acquired biometric image data with a biometric image data stored at one or more of said gaming server and said non-gaming server, if a match is made (iii) associate a player with an identified player account at one or more of said gaming server and said non-gaming server or an established anonymous player account at said gaming server to provide access thereto or in the event a match is not made to (iv) establish a new anonymous player account at said gaming server and associate said acquired biometric image data for said player who cannot be identified and data from said second server with said new anonymous player account and provide access thereto.

6. The system of claim 5 comprising said second device is a cellular telephone and said electronic communication is near-field communication.

7. The system of claim 5 comprising said gaming server configured to charge against said chargeable account for gaming.

8. The system of claim 5 wherein gaming is subject to a geographic area restriction and said devices are configured for determination of the geographic location of the device and providing data corresponding to said location to said at least one gaming server, said system comprising said gaming server is configured to determine if said gaming device is located in said geographic area and if so to enable said gaming device for play and if not to disable said device for play.

9. A method for play of gaming devices communicating over a first network to at least one remote gaming server where said gaming devices are configured to interface through electronic communication with a second device, said second device enabling access to a non-gaming account server with data associated with one or more of chargeable account, password and biometric information; said method comprising:
storing player gaming account data at a remote gaming server and memory device, said account data including (i) biometric image data for identified players and unidentified, established anonymous players and (ii) data associated with one or more of chargeable account, password and biometric information associated with said second server;
at said gaming devices acquiring biometric image data of a substantially unique biometric feature of a player, one of said sensors or gaming devices configured to provide the biometric image data to the at least one gaming server through said first network;
said devices configured for determination of the geographic location of the device and for providing data corresponding to said location to said gaming server;
configuring said gaming server for (i) receiving from said gaming devices account information from said non-gaming server via said electronic communication between said gaming device and said second device, (ii) matching the acquired biometric image data with biometric image data stored at one or more of said gaming server and said non-gaming server, if a match is made (iii) associating the player with an identified player account at one of said gaming server and said non-gaming server or establishing a anonymous player account at said gaming server to provide access thereto or in the event a match is not made (iv) establishing a new anonymous player account at said gaming server and associating said acquired biometric image data for said player who cannot be identified and data from said second server with said new anonymous player account and provide access thereto.

10. The method of claim 9 comprising said second device is a cellular telephone and said electronic communication is near-field communication.

11. The method of claim 9 comprising said configuring the gaming server to enable charging against said chargeable account for gaming.

12. The method of claim 9 wherein gaming is subject to a geographic area restriction and said devices are configured for determination of the geographic location of the device and providing data corresponding to said location to said at least one gaming server, said method comprising configuring said gaming for determining if said gaming device is located in said geographic area and if so to enabling said gaming device for play and if not disabling said device for play.
